(19) United States
(12) Patent Application Publication
(10) Pub. No.: US 2014/0368649 A1
(43) Pub. Date: Dec. 18, 2014

(54) Image Recognition System Controlled Illumination Device

(71) Applicant: Kaipo Chen, Taoyuan Hsien (TW)

(72) Inventor: Kaipo Chen, Taoyuan Hsien (TW)

(21) Appl. No.: 14/472,403

(22) Filed: Aug. 29, 2014

Related U.S. Application Data
(63) Continuation-in-part of application No. 13/220,720, filed on Aug. 30, 2011.

(30) Foreign Application Priority Data
Jun. 24, 2014 (CN) 201410289447.5

(51) Int. Cl. H04N 7/18; H04N 5/225

(52) U.S. Cl. CPC H04N 7/183; H04N 5/2256
USPC 348/143

(57) ABSTRACT

An image recognition system controlled illumination device includes an imaging device that includes therein an imaging module for capturing an image so that an image recognition device recognizes the captured image with transmission thereof being made to a CPU microprocessor, so that the CPU microprocessor issues a signal to simultaneously activate an illumination module and a storage module connected thereto to perform operations of illumination and image recording and storage and with an image database and a comparison module, recognition of an image is made under additional constraints to achieve accuracy of recognition. Further included is an add-on function module including a sound effect module, a wireless module, and a WIFI module, which is connected to the CPU microprocessor, so as to increases the functions activated by the CPU microprocessor to achieve flexibility of use of the recorded image storage space and accomplishment of accuracy of image comparison.

### CROSS REFERENCE TO RELATED APPLICATION

This application is a continuation-in-part of copending U.S. patent application Ser. No. 13/220,720 filed on Aug. 30, 2011.

### BACKGROUND OF THE INVENTION

(a) Technical Field of the Invention

The present invention generally relates to an image recognition system, and more particularly to an image recognition system that recognizes an object entering a detection range so as to control an illumination device to perform a related operation.

(b) Description of the Prior Art

A conventional surveillance security system has a major advantage of using a centralized control center to carry out surveillance operations or being in connection with a police station for the simple purposes of preventing burglary invasion and thus avoiding damage of property. However, the conventional system uses cameras that are installed at easily-observable sites and may be slightly bulky in size. On the other hand, a surveillance device that is combined with sensing-based lighting is also available for the purposes of sensing an object entering a detection range to activate lighting for alarming reminder and also to activate image recording operations of the surveillance device. For whatever types of the known surveillances used, if the number of the surveillances installed in not enough, burglary can finds a way to avoid the range where recording of image may be available, making the installation of the conventional surveillance security system total in vein.

With the progress of technology and science, the image capturing devices that are currently available in the market are generally achieved by installing miniature cameras. Due to being small in size and being wide in applications, they are commonly used for to carry out photographing in a concealed location for evidence collection, surveillance, and search for law upholding. However, they suffer certain drawbacks for they need to be operated by being manually controlled through control buttons. Some manufacturers proposed to combine such cameras or imaging devices with illumination devices. However, the proposed solution is always put into operation when power is turned on to make illumination and also to make imaging and recording. Such an operation may be prolonged for an extended period of time so that the device may run out of storage capacity thereof or the image quality of recording must be downgraded. All these problems and shortcomings require further improvements.

### SUMMARY OF THE INVENTION

The present invention provides an image recognition system controlled illumination device, which comprises: an imaging device, which comprises therein an imaging module, an image recognition device, and a CPU microprocessor, wherein the imaging module captures an image to be transmitted to the image recognition device for recognition therein and subsequent issuance of a message to the CPU microprocessor, so as to simultaneously an illumination module and a storage module connected to the CPU microprocessor to perform functions of illumination and image recording and storage. Additionally, an add-on function module is provided for connection with the CPU microprocessor for providing and activating additional functions that are desired.

Compared to the drawbacks of the prior art, the present invention uses an imaging module to capture an image, which is applied to an image recognition device for determining if a moving object image is identified in a range of sensing so as to operate in combination with a CPU microprocessor to issue a signal for activation of an illumination module and a storage module to perform operations of illumination and image recording and storage and an image database and a comparison module for comparison thereby improving a meaningless waste of recorded image storage space found in the prior art and allowing for an effective use of the recorded image storage space for storage of images of value of use.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a flow chart of a first embodiment of the present invention.

FIG. 2 is a system block diagram of the first embodiment of the present invention.

FIG. 3 is a flow chart of a second embodiment of the present invention.

FIG. 4 is a system block diagram of the second embodiment of the present invention.

FIG. 5 is a schematic view showing an application of the present invention.

FIG. 5A is a schematic view showing a portion of an arrangement of the application of the present invention.

FIG. 6 is a schematic view showing another application of the present invention.

FIG. 6A is a schematic view showing a portion of an arrangement of the application of the present invention.

FIG. 7 is a schematic view showing a further application of the present invention.

FIG. 7A is an enlarge view showing a portion of an arrangement of the application of the present invention.

FIG. 8 is a schematic view showing a further application of the present invention.

FIG. 8A is a schematic view showing a portion of an arrangement of the application of the present invention.

FIG. 9 is a schematic view showing a further application of the present invention.

FIG. 10 is a schematic view showing a further application of the present invention

FIG. 11 is a schematic view showing a further application of the present invention.

FIG. 12 is a schematic view showing a further application of the present invention.

FIG. 12A is a schematic view showing a portion of an arrangement of the application of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

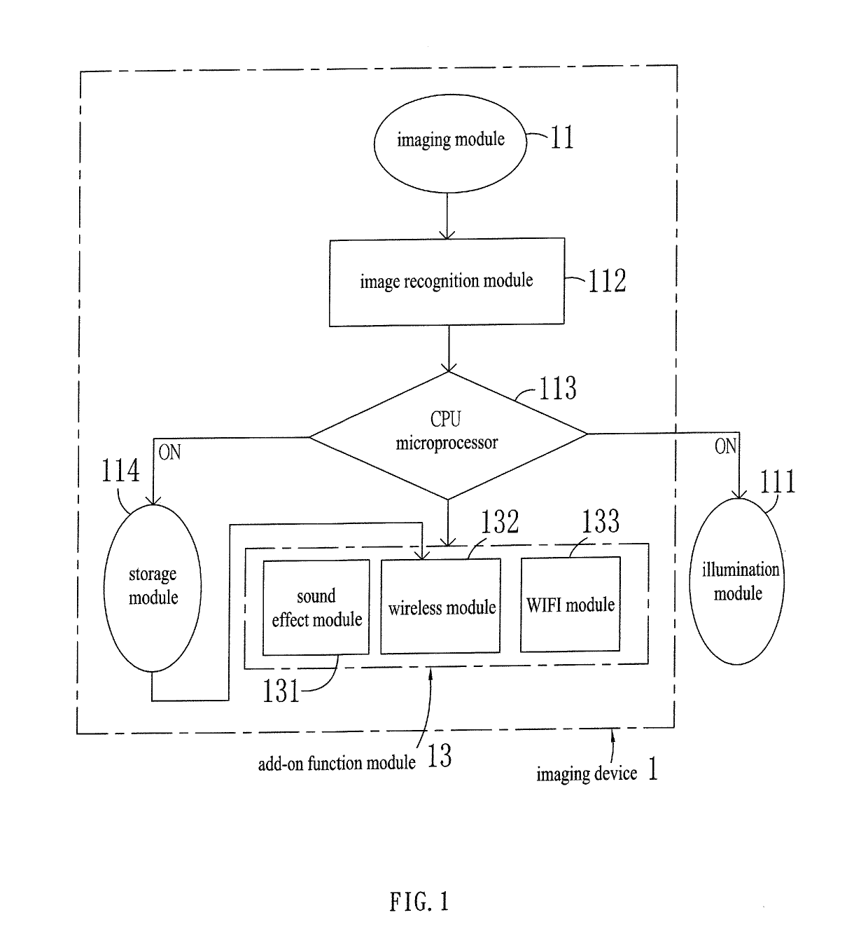

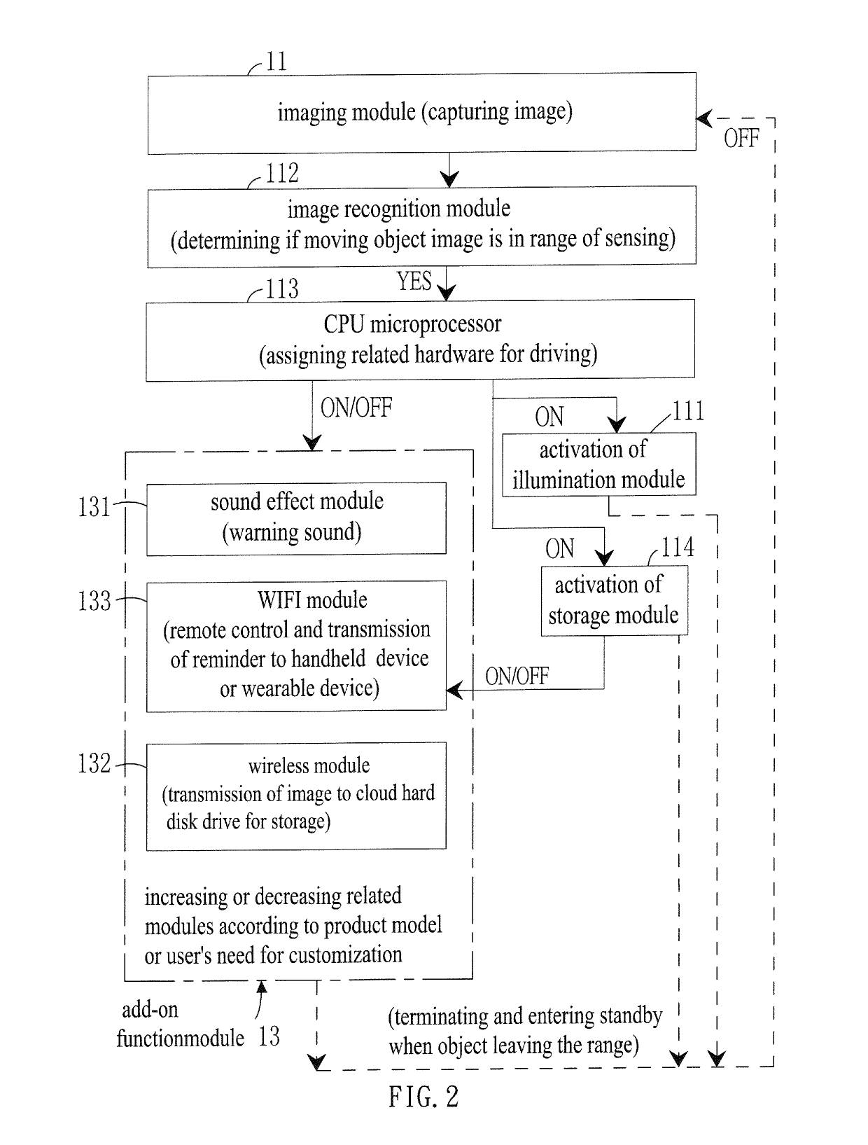

Referring to FIGS. 1 and 2, which show a first embodiment of the present invention, the present invention provides an image recognition system controlled illumination device, which comprises: an imaging device (1) that comprises therein an imaging module (11), which captures and acquires an image, wherein the imaging module (11) can be a camera lens; and an image recognition device (112), which determines if the image (14) acquired by the imaging module (11) is a moving object image and does not transmit any signal if it is not and transmits a signal to a CPU microprocessor (113) if it is a moving object image so that the CPU microprocessor (113), upon receipt of the signal, activates simultaneously an illumination module (111) and a storage module (114) electrically connected thereto, wherein the illumination module (111) can be a light-emitting diode and the storage module (114) can be a read-only memory or a flash memory, but not limited thereto, in order to carry out operations of illumination and storage of recorded image.

The CPU microprocessor (113) is further connected to an add-on function module (13). The add-on function module (13) comprises: a sound effect module (131), which supplies a warning sound or an audio reminder, a wireless module (132), which is used with a handheld device or a wearable device to transmit a reminder message or to effect remote control, and a WIFI module (133), which is connected to the storage module (114) to detect the used capacity of the memory of the storage module (114) in order to receive an additional supply of an external space that is connectable through a network or an internally built-in memory of the WIFI module (133) to achieve image recording for an extended period of time. The add-on function module (13) may be structured to increase or decrease the number of modules included therein according to the model of a specific product or the need of a user so as to achieve customization and to eliminate constraints of field wire laying. When the object gets outside a range of sensing, operations including illumination, image recoding, and those of the add-on function module (13) are shut down and put in a waiting condition for re-activation when a next object entering the range of sensing.

In the first embodiment, an advantage is saving of electrical power and storage space, for the storage space will be used to store recorded image only when determination is made by the image recognition device (112) that there is a moving object image in the range of sensing. This greatly reduce the waste of the storage space of the recorded image. Further, the add-on function module (13) is additional provided to provide the present invention with various functions for the purpose of customization.

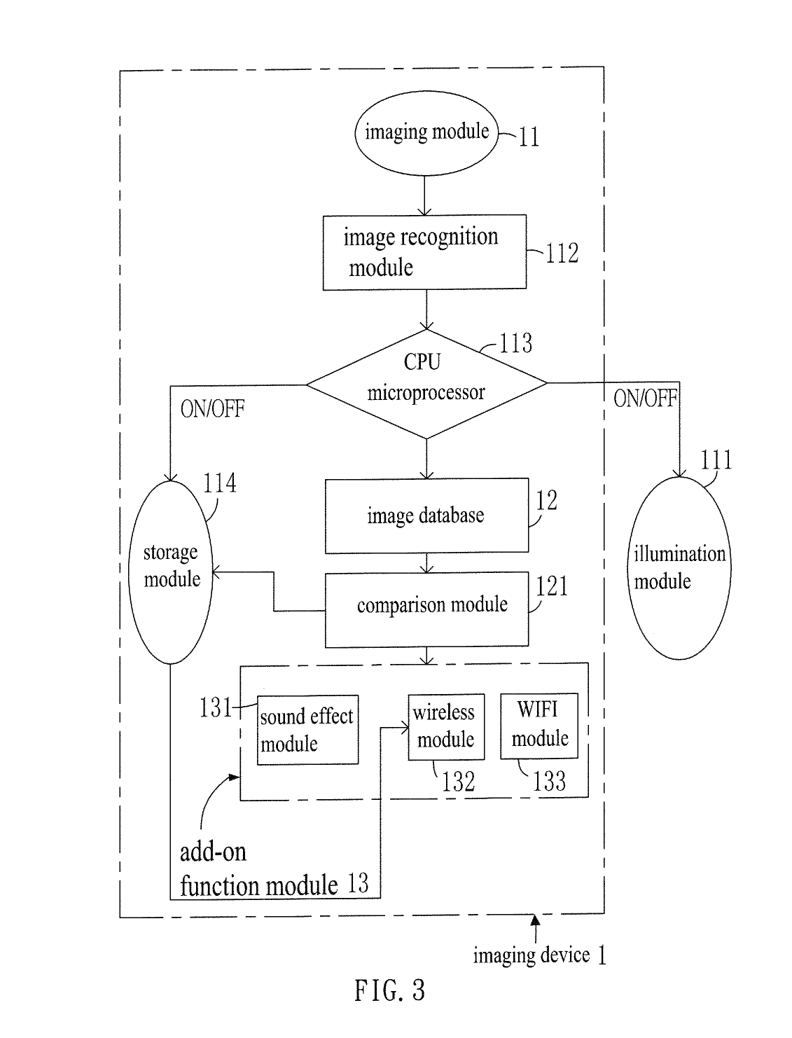

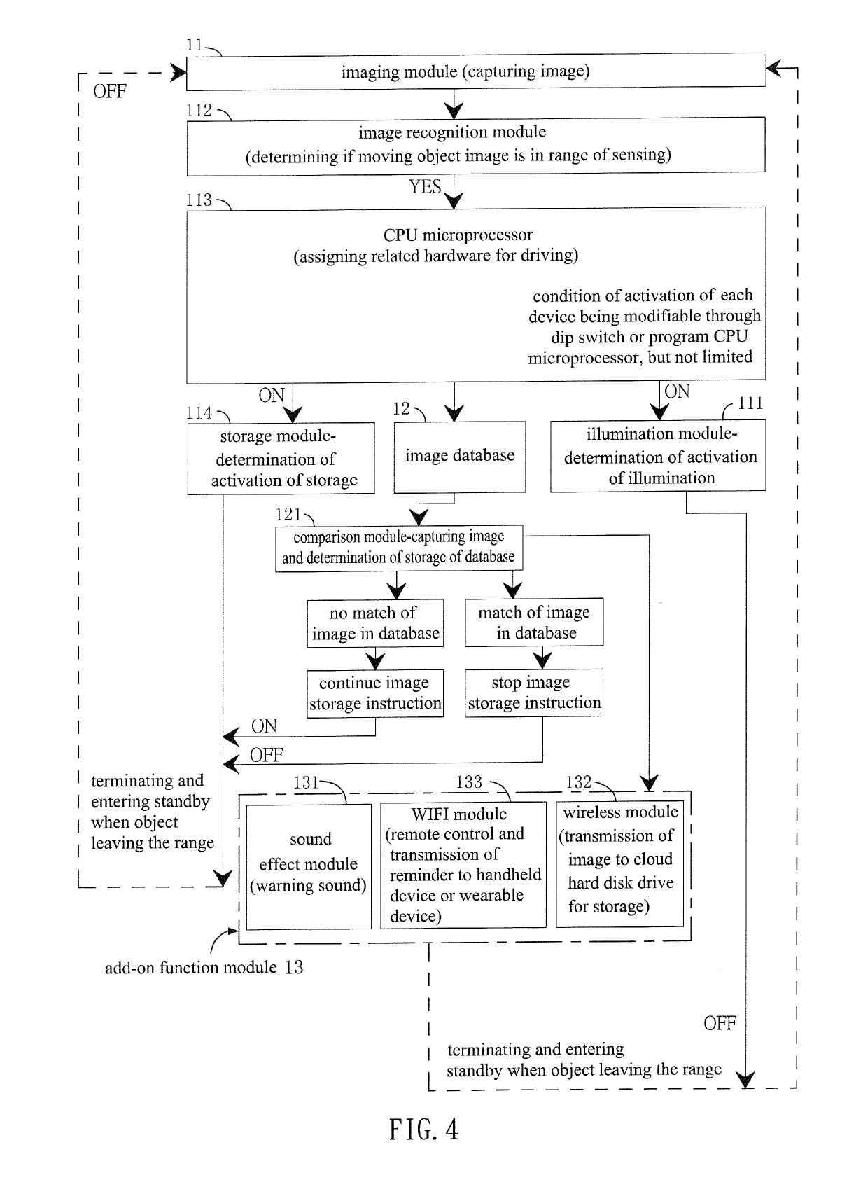

Further referring to FIGS. 3 and 4, which show a second embodiment, the second embodiment is structured by adding an image database (12) and a comparison module (121) to the structure of the first embodiment, wherein the image database (12) is connected to the CPU microprocessor (113) and the image database (12) is also connected to the comparison module (121), so that the CPU microprocessor (113), when receiving the signal discussed previously and activating the illumination module (111) and the storage module (114), simultaneously activates the image database (12), wherein the image database (12) is loaded in advance with images (14) for the purposes of determining if an object matches the previously loaded images (14), where the amount of image stored in not subjected to any specific limitations or constraints (and is generally determined according to the amount of memory provided), and receives an image (141) acquired by the imaging module (11), which is transmitted through the CPU microprocessor (113) to the comparison module (121) for determining, together with the image database (12) connected thereto, if there is a match with the previously-loaded images (14), so that image recoding and storage continue if there is no match of the images loaded in the image database (12), otherwise, upon identification of a match with the images loaded in the image database (12), a signal is transmitted to the storage module (114) to stop storage of the recorded image, while the operation of the illumination module (111) is not affect and lighting remains altered. The comparison module (121) is further connected to an add-on function module (13). The add-on function module (13) may comprise: a sound effect module (131), which supplies a warning sound or an audio reminder, a wireless module (132), which is used with a handheld device or a wearable device to transmit a reminder message or to effect remote control, and a WIFI module (133), which is connected to the storage module (114) to detect the used capacity of the memory of the storage module (114) in order to receive an additional supply of an external space that is connectable through a network or an internally built-in memory of the WIFI module (133) to achieve image recording for an extended period of time. The add-on function module (13) may be structured to increase or decrease the number of modules included therein according to the model of a specific product or the need of a user so as to achieve customization and to eliminate constraints of field wire laying. When the object gets outside a range of sensing, operations including illumination, image recoding, and those of the add-on function module (13) are shut down and put in a waiting condition for re-activation when a next object entering the range of sensing.

In the second embodiment, the image database (12) and the comparison module (121) are additionally included for the purposes of improving the conditions of recognition, where besides determining if an image detected by the image recognition device (112) is a moving object image, the image database (12) may be subjected to storage and removal of related images (14) therein so that in a subsequent operation of determination carried out in the comparison module in respect of an image, if it is an image (14) loaded in the image database (12), then it is determined that the image is a known person (such as a family member, a friend, and a relative) and image recording is stopped; and if it is an image (14) other than those of the image database (12), the image recording keeps on, whereby an effective use of the entirety of the storage space can be enhanced.

Referring to FIGS. 1-4, the two embodiments are both provided with the add-on function module (13) and a major difference is regarding the driving signal, where in one of them, the driving is directly made with the CPU microprocessor (113), while in the other one, re-determination of an image must be made through the image database (12) and the comparison module (121) before driving is made so that comparison of image can only be performed with additional constraints to thereby achieve a purpose of accuracy of determination.

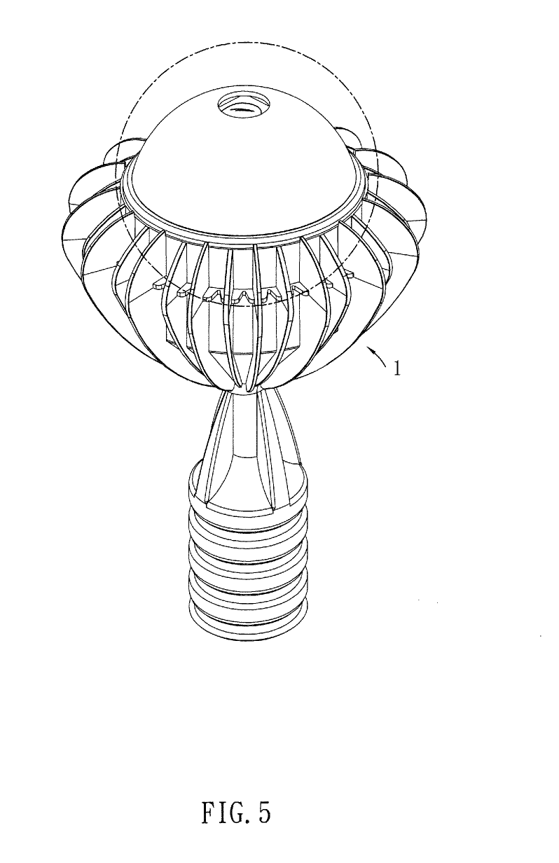

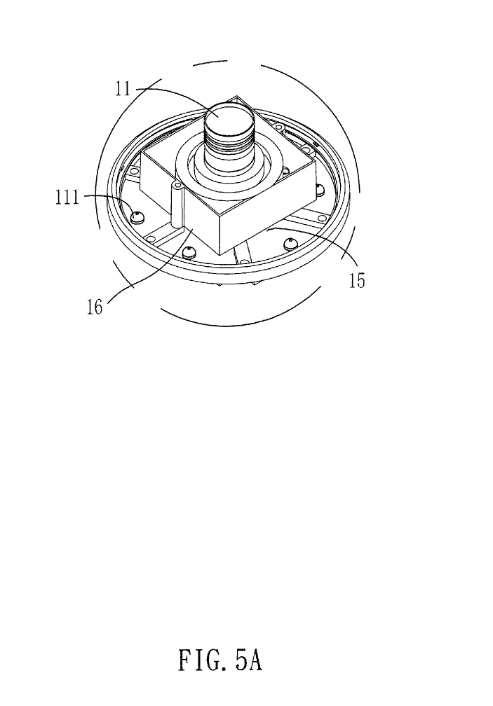

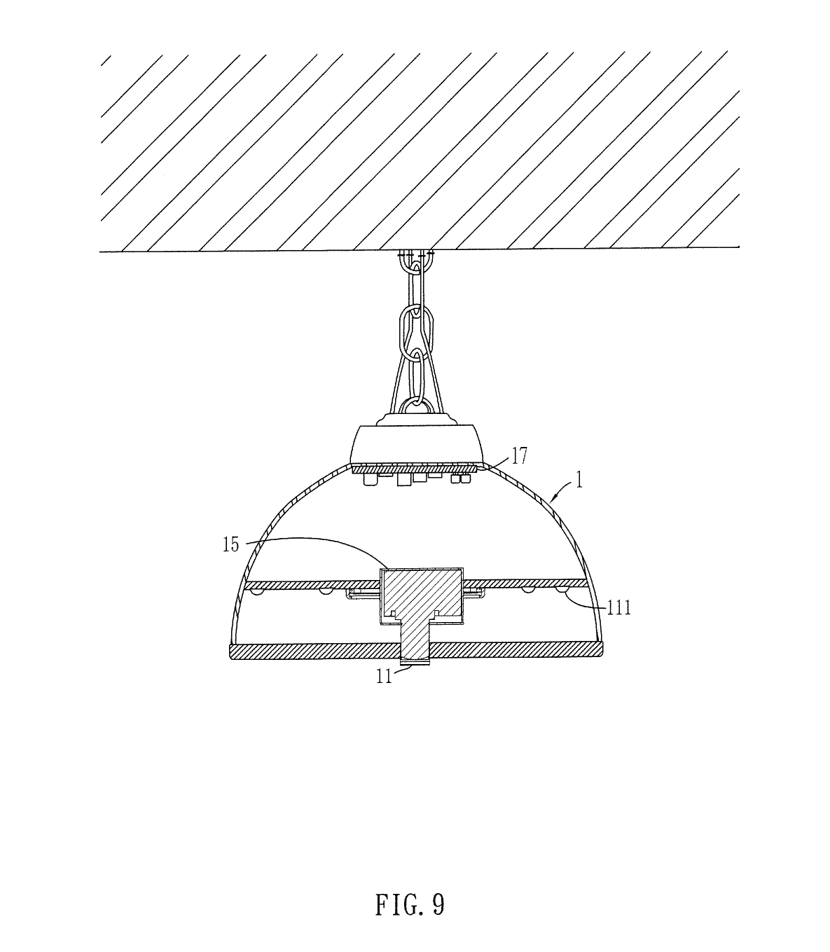

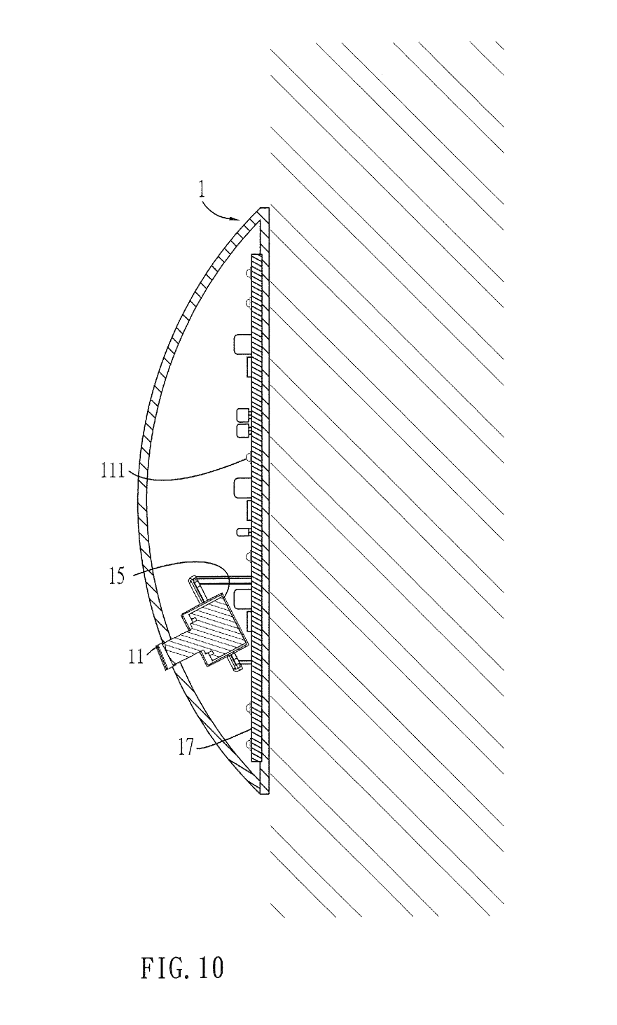

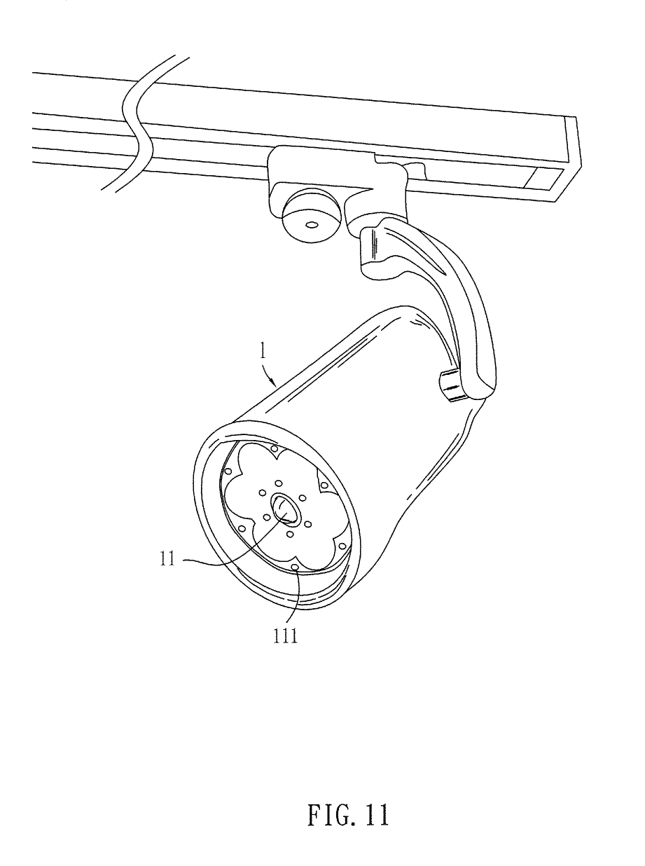

In the following example applications shown in FIGS. 5-12, a power supply board (17) is provided and is set at a position that is subjected to no specific constraint with a major function of supplying necessary electrical power. The circuit board (15), which was discussed previously, is generally arranged inside the imaging device (1) with a major function of being arranged with the related modules to carry out the process flows illustrated in the first embodiment of the second embodiment, so that a description in regard to the relative position and the use thereof is given in advance for easy reference and convenience of reading.

Referring to FIGS. 5-7A, in each of which the imaging device is respectively embodied in the form of a regular light bulb, a fluorescent light tube, and a ceiling lighting fixture, FIG. 5 shows an imaging device (1), which comprises a circuit board (15) therein. The outside is provided with a rotatable seat (16) for attaching to a power supply board (17). The circuit board (15) comprises chips of various functions mounted thereon and the circuit board (15) is connected to one or more than one illumination module (111). The specific illumination module (15) is a regular LED based light emission device. Coupling means of the illumination module (111) is the same as the measure adopted in the first and second embodiments of being arranged to be separate from the imaging device (1). The rotatable seat (16) further comprises therein an imaging module (11) for image recording. Based on the contents of the flow chart of the first embodiment that is discussed previously, together with FIGS. 5 and 5A, it can be easily appreciated that in the application to a regular light bulb, the imaging module first acquires an image and data is then transmitted to the circuit board (15), where the chips included in the circuit board (15) comprise the imaging module (11), the image recognition device (112), the CPU microprocessor (113), the storage module (114), and the add-on function module (13) and the add-on function module (13) further comprises: the sound effect module (131), the wireless module (132), and the WWI module (133), so that the modularized arrangement allows for substitute and selection of the functions that are desired for use. The functions of the modules have been described previously. Further, the previously discussed the illumination module (111) may be installed in a different way, where the illumination module (111) is directly mounted to the circuit board (15) so as to achieve the purposes of reduction of the size and of the imaging device (111) or addition of further components.

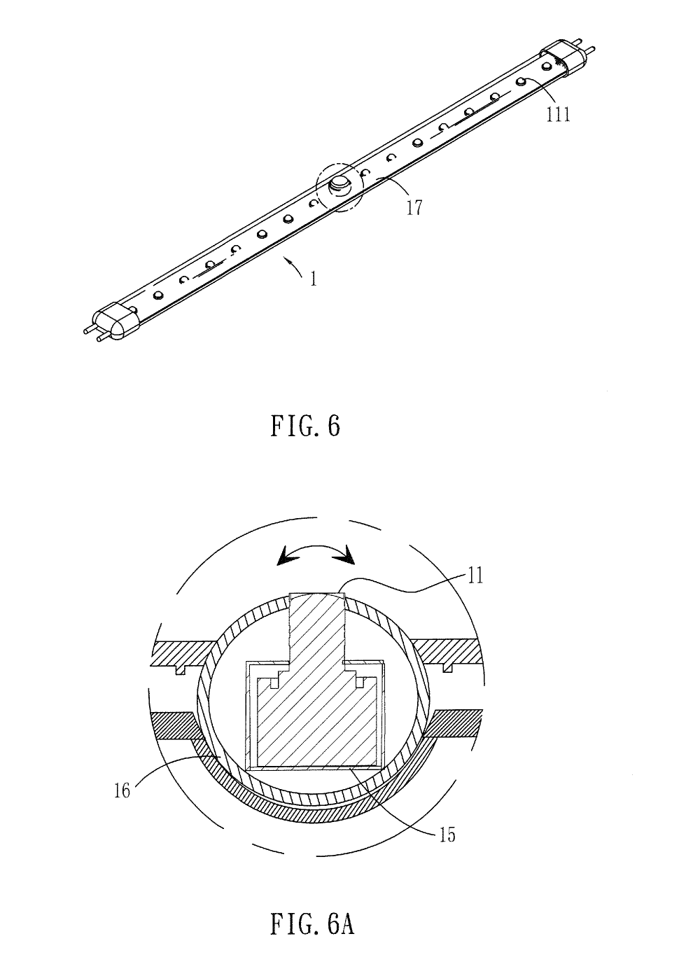

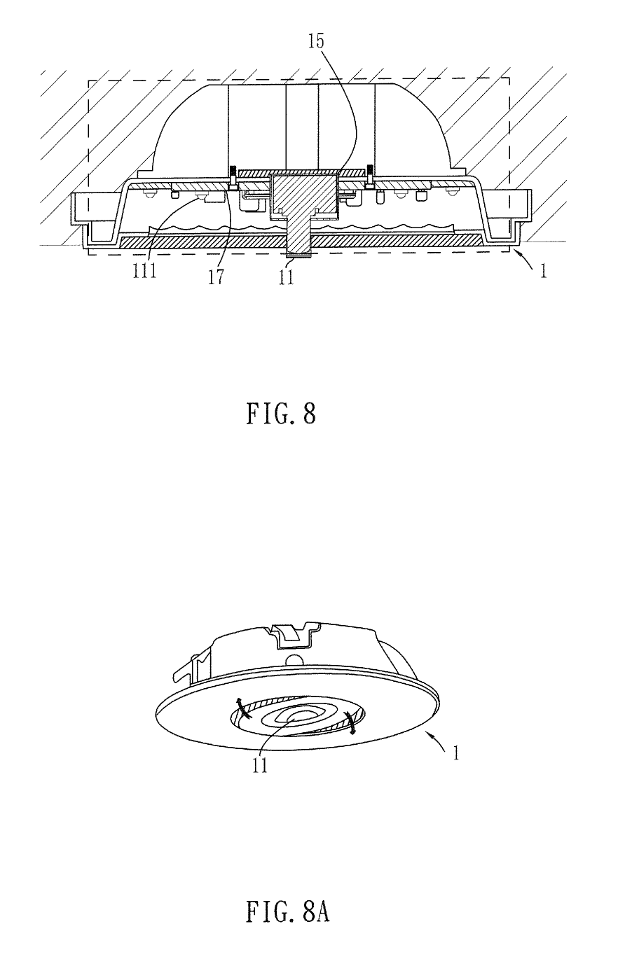

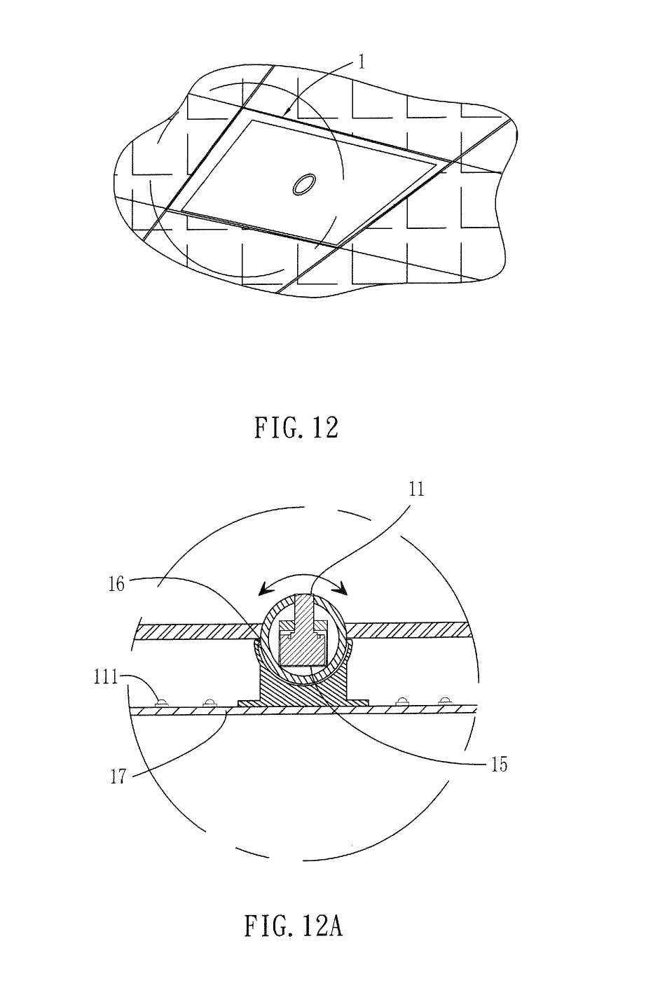

FIGS. 6 and 6A show an example of a fluorescent light tube. In the fluorescent light tube, the rotatable seat (16) further provides a function of rotation in order to adjust the orientation of the imaging module (11) for the purposes of capturing images of different angles. FIGS. 8 and 8A and FIGS. 12 and 12A respectively show an embedded light and an LED panel light, which further comprise the rotatable seat (16) used for rotation in the fluorescent light tube. The circuit board (15) further comprises an image database (12) and a comparison module (121). When an image captured by the imaging module (11) is transmitted through the image recognition device (112) to the CPU microprocessor (113) to have the illumination module (111) and the storage module (114) simultaneously activated, the CPU microprocessor (113) also transmits a signal to the image database (12), which, through determination made with the comparison module (121), issues a signal regarding if the storage module (114) stops a recording operation or maintains the recording operation. The storage module (114) is also connected with the add-on function module (13) to carry out the contents of the flow chart discussed with reference to the second embodiment.

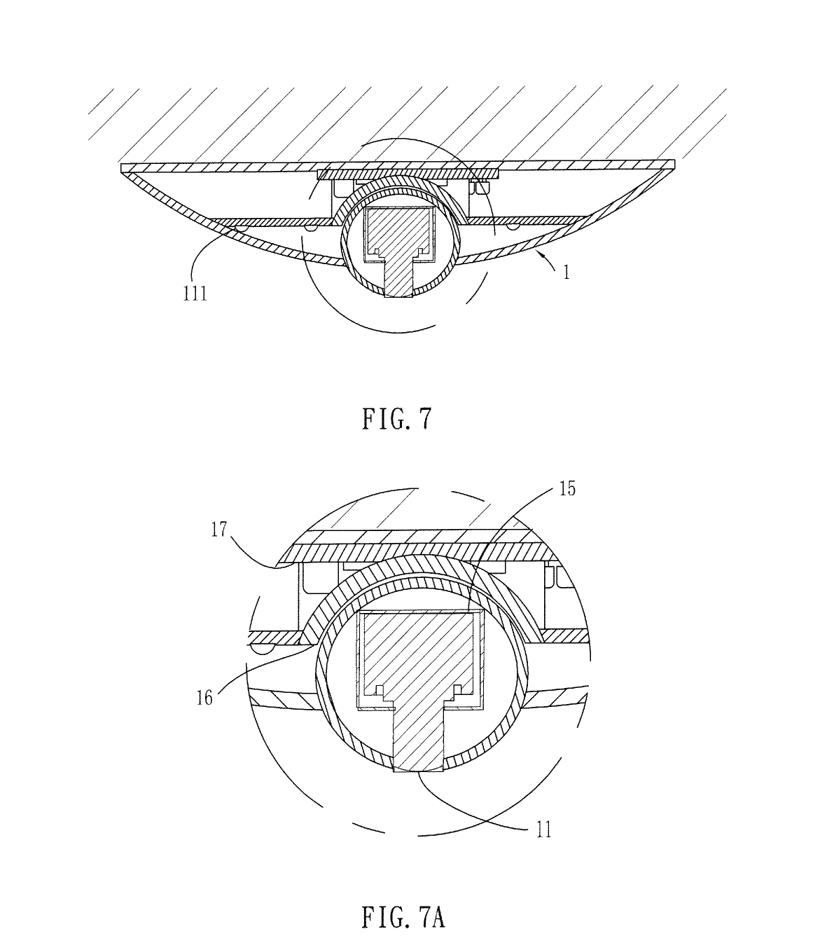

The structure and operation flow of the imaging module (11) as discussed previously is applicable to and used with various arrangements of the imaging device. For example, those illustrated in FIGS. 7 and 7A and FIGS. 9-11 are respectively a ceiling lighting fixture, a pendant light, a wall lighting fixture, and a track light, but the present invention is not limited to the examples mentioned herein. Within the scope of understandability, it is appreciated that the imaging module (11) can be mounted to a rotatable seat (16) that does not allow for rotation to adjust orientation in order to enhance fixation of position or a rotatable seat (16) that allows for rotation for adjusting the orientation so that angle adjustment can be achieved with the rotatable seat (16), together with the image recognition device (112) that was discussed previously for recognition of image, for driving the illumination device (111), so that it can be further appreciated that the present invention generally uses image recognition to drive the illumination device (111).

For the practical applications mentioned herein, for one with no rotatable structure, the process flow discussed with reference to the first embodiment is recommended, where activation of related modules is achieved only with acquirement of image; and for one with a rotatable structure, the process flow discussed with reference to the second embodiment is recommended, where an image database (12) and a comparison module (121) are further included to allow for further image determination before activation of related modules is made, making the invention more widely applicable. However, in the entirety of the structure, the use of the ones with or without the rotatable structure does not have to follow the process flows discussed herein and alternatively, the process flow of the second embodiment may be applied to a no-rotation structure, but it is not possible to acquire images of different angles for the operations of the comparison module (121).

In summary, the present invention makes use of acquirement of image, which after being recognized, is used with the CPU microprocessor to drive the storage module and the illumination module, so that determination is upgraded to image recognition, instead of the conventional way of thermal sensing. Further, with data pre-loaded in the image database and recognition and determination made with the comparison module, the storage space for image recoding can be adjusted to the most effective use; and the add-on function module is provided to increase or decrease the functions used or desired so as to suit the need of a user, making the present invention more flexible in the storage space of image recoding and the accuracy of recognition or determination of image is improved through multiple operations of image recognition.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An image recognition system controlled illumination device, comprising:
an imaging device, which comprises therein an imaging module, which acquires an image; an image recognition device, which recognizes the image acquired by the imaging module to be subsequently transmitted to a CPU microprocessor, so that the CPU microprocessor simultaneously activates an illumination module and a storage module connected thereto to carry out operations of illumination and image recording and storage.

2. An image recognition system controlled illumination device, comprising:
an imaging device, which comprises therein an imaging module, which acquires an image; an image recognition device, which recognizes the image acquired by the imaging module to be subsequently transmitted to a CPU microprocessor, so that the CPU microprocessor simultaneously activates an illumination module and a storage module connected thereto to carry out operations of illumination and image recording and storage, the CPU microprocessor being connected to an add-on function module.

3. The image recognition system controlled illumination device according to claim 2, wherein the add-on function module further comprises: a sound effect module, which supplies a warning sound, a wireless module, which transmits a reminder, and a WIFI module, which transmits a stored image, each of the modules being connected to and driven by the CPU microprocessor, the WIFI module being connected to the storage module for the storage module to store of recorded images.

4. An image recognition system controlled illumination device, comprising:
an imaging device, which comprises therein an imaging module, which acquires an image; an image recognition device, which recognizes the image acquired by the imaging module to be subsequently transmitted to a CPU microprocessor, so that the CPU microprocessor simultaneously activates an illumination module and a storage module connected thereto to carry out operations of illumination and image recording and storage, the CPU microprocessor being connected to an add-on function module, wherein the add-on function module further comprises: a sound effect module, which supplies a warning sound, a wireless module, which transmits a reminder, and a WIFI module, which transmits a stored image, each of the modules being connected to and driven by the CPU microprocessor, the WIFI module being connected to the storage module for the storage module to store of recorded images; an image database, which is loaded therein at least one image and in connected with the CPU microprocessor for transmission of the captured image to a comparison module for comparison, the comparison module being further connected with the storage module in order to control an operation condition of image recoding of the storage module.

5. The image recognition system controlled illumination device according to claim 1 further comprising: a rotatable seat, the rotatable seat being arranged outside the imaging module, the rotatable seat being fixed or adjustable to improve fixation of the imaging module or to adjust the rotatable seat to change a viewing range of the imaging module in order to capture different images.

6. The image recognition system controlled illumination device according to claim 2 further comprising: a rotatable seat, the rotatable seat being arranged outside the imaging module, the rotatable seat being fixed or adjustable to improve fixation of the imaging module or to adjust the rotatable seat to change a viewing range of the imaging module in order to capture different images.

7. The image recognition system controlled illumination device according to claim 4 further comprising: a rotatable seat, the rotatable seat being arranged outside the imaging module, the rotatable seat being fixed or adjustable to improve fixation of the imaging module or to adjust the rotatable seat to change a viewing range of the imaging module in order to capture different images.
